(19) United States
(12) Patent Application Publication
(10) Pub. No.: US 2008/0207055 A1
(43) Pub. Date: Aug. 28, 2008

(54) Electrical connector with spike protection and method for production of a spike protection for electrical connectors

(75) Inventor: Helmut Buttner, Heroldsbach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 12/069,977

(22) Filed: Feb. 14, 2008

(30) Foreign Application Priority Data
Feb. 22, 2007 (DE) 10 2007 008 740.5

(51) Int. Cl. H01R 13/648

(52) U.S. Cl. 439/607

(57) ABSTRACT

The present invention relates to an electrical connector with spike protection with an at least partially metalized housing which has a cable end and a plug end. A protective sheath made of dielectric material surrounds the entire connector and forms an apron extended out over the housing in the area of the mating face of the connector in the mating direction.

### CROSS REFERENCE TO RELATED APPLICATIONS

This application claims priority of German application No. 10 2007 008 740.5 filed Feb. 22, 2007, which is incorporated by reference herein in its entirety.

### FIELD OF THE INVENTION

The present invention relates to an electrical connector with spike protection and a method for production of a spike protection for electrical connectors with at least partially metalized housings.

### BACKGROUND OF THE INVENTION

Many electrical devices, including medical imaging devices such as magnetic resonance devices or medical computer tomographs, have a plurality of electronic components which are connected to one another by electrically conductive cables. Many of these cables are electrically shielded cables, such as coax cables, to prevent signals transmitted through the cables from being corrupted by electromagnetic interference (EMI). Electrical connectors on the ends of these cables frequently have a metalized housing which is conductively connected to the shielding of the electrical cable, to prevent any gaps arising in the shielding. The metal or metalized connector housings must not come into contact with metal objects, since this results in interference (spikes) affecting the images when MR recordings are taken.

It has long been the practice to try to prevent connector housings touching one another by fixing cables with cable binders. Connected connector pairs were also covered with shrinkdown tubing, which has the disadvantage that this was invariably destroyed when the connector was unplugged and was often not replaced by the user of the MR equipment. In the prior art, printed patent specification DE 4302153 C2 discloses a connector with a metal housing surrounded by an insulating protective housing which forms an apron which can be extended out over the housing in the mating direction. DE 3928187 A1 describes a protective housing for a district cable TV service box, which uses shrinkdown tubing. U.S. Pat. No. 4,063,793A describes a protective sheath which is essentially intended for waterproofing, but could also be used for spike protection.

### SUMMARY OF THE INVENTION

The object of the present invention is to specify an electrical connector with spike protection and a method for production of a spike protection for electrical connectors, which cannot be destroyed in error by the user when a connector is unplugged and which provides secure protection against spikes.

This object is achieved in accordance with the claims. Features of preferred embodiments of the present invention are characterized in the subclaims.

The idea underlying the present invention is that instead of encasing a connected connector pair in shrinkdown tubing, which is destroyed when the connector is unplugged, each individual plug should be provided with shrinkdown tubing having an apron on the plug end, said apron meeting the apron of a complementary connector or a wall of a housing, in order thus to provide secure protection against the metal plug housing touching other metal objects.

The method is extremely economical, since it is easy to apply and does not necessarily require expensive devices as a plug-in attachment.

Suitable shapes made of sheet metal or plastic sections can easily be laminated or bent for the plug-in attachment.

Thus mass production is not required, but it can also be used economically for individual items.

The plug-in attachment can be in the shape of a funnel, or else of a somewhat wider cylinder or cuboid, so long as the internal width is bigger than the plug to be plugged in.

The method is not tied to a workbench, but can also easily be performed subsequently on building sites on existing systems.

### BRIEF DESCRIPTION OF THE DRAWINGS

The invention is described in greater detail below on the basis of the explanation of an exemplary embodiment with reference to the drawing, in which:

FIG. 1 shows an example of a plug with metal housing and a cable connected thereto;

FIG. 2A a perspective rear view of a plug-in attachment according to an exemplary embodiment of the present invention;

FIG. 2B a top view of a plug-in attachment according to FIG. 2A;

FIG. 3 the connector according to FIG. 1 with the plug-in attachment according to FIG. 2 and shrinkdown tubing;

FIG. 4 shrinkdown tubing shrunk onto the connector with extended apron.

### DETAILED DESCRIPTION OF THE INVENTION

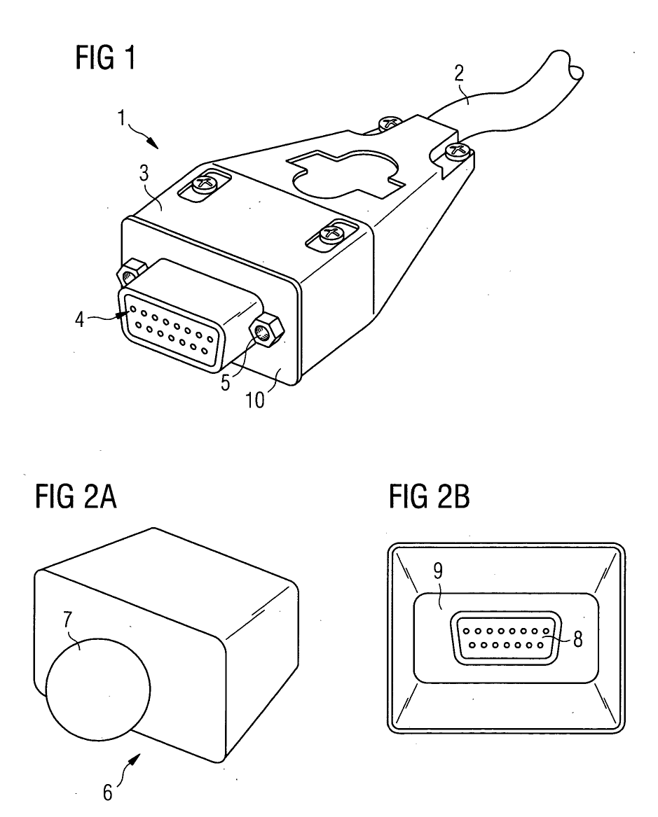

FIG. 1 shows an electrical connector 1 with a cable 2 attached thereto. The housing 3 of the connector 1 consists entirely of metal. On the end face of the connector 1 is the mating face 4, which in the example shown is in the shape of a matrix of contact sockets. On both sides of the female part of the connector are threaded holes, into which the screws arranged on a mating connector (not shown) can be inserted to secure the plug-in connection.

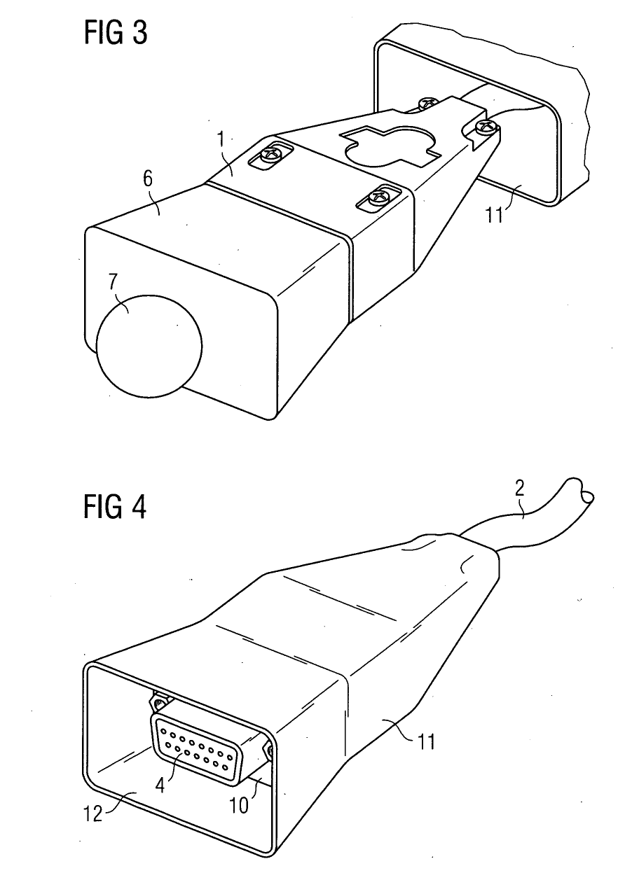

FIG. 2A shows a perspective view of a plug-in attachment 6, obliquely from behind. To facilitate handling of the plug-in attachment a knob 7 is attached to the back thereof to facilitate removing the plug-in attachment from the plug-in attachment 1 if shrinkdown tubing is shrunk on. FIG. 2B shows the plug-in attachment from the front. A plug 8 with pin contacts which is complementary to the female connector 4 can be seen. It is not essential for the plug 8 to be implemented in operational condition. It is also sufficient if only its apron which is plugged into the plug 4 is present. It can be seen in FIGS. 2A and 2B that the plug-in attachment takes the form of a truncated pyramid or of a funnel. The dimensions of the smaller rectangular surface 9 correspond to those of the face plate 10 of the connector 1.

FIG. 3 shows a part of shrinkdown tubing 11 which has not yet been shrunk and which has been wrapped over the connector 1 onto the cable 2. The plug-in attachment 6 is plugged into the mating face 4 of the connector 1 and it can be seen that the plug-in attachment 6 continuously extends the top, bottom and side walls of the connector 1, the plug-in attachment extending in the direction of the handling knob 7. The shrinkdown tubing 11 is cut to a suitable length and is then pushed over the connector 1 and the plug-in attachment 6 and is heated, for example with a hot-air fan, so that it shrinks and assumes the contours of the connector together with the plug-in attachment 6. Once the shrinkdown tubing has cooled, the plug-in attachment 6 is pulled off the connector 1 by the handling knob 7. The spike-protected connector 1 is shown in FIG. 4. It can be seen that an apron made of shrinkdown tubing material is arranged around the mating face 4 and the face plate 10, and leaves enough space around the face plate 10 so that there is nothing to prevent the connector 1 being plugged together with a complementary plug. The shrinkdown tubing material is generally of a rubber type, so that the apron can be slightly compressed if the connector 1 for example is plugged into the plug panel of an electrical device. If the connector 1 is connected to a complementary connector that likewise has a spike protection, the aprons opposite one another can likewise be compressed, which in no way impairs the object of spike protection. Depending on the intended use, the apron 12 can be cut to a suitable length.

The above description of an exemplary embodiment of the present invention is merely for illustrative purposes and should not be understood as being restrictive.

1.-6. (canceled)

7. An electrical connector with spike protection, comprising:
a housing that has a cable end and a plug end; and
a protective sheath that surrounds the connector and forms an apron extending out over the housing in a mating direction in an area of a mating face of the connector, the apron extending out from the mating face in a funnel shape in the mating direction.

8. The electrical connector as claimed in claim 7, wherein the protective sheath is a shrinkdown tubing made of a material that shrinks after heating.

9. The electrical connector as claimed in claim 7, wherein the housing is at least partially metalized.

10. The electrical connector as claimed in claim 7, wherein the protective sheath is made of a dielectric material.

11. The electrical connector as claimed in claim 10, wherein the dielectric material can be deformed elastically at least in an area of the apron.

12. A method for producing a spike protection for an electrical connector, comprising:
plugging a plug-in attachment onto a mating face of the connector;
inserting the connector with the plug-in attachment into a shrinkdown tubing;
shrinking the shrinkdown tubing onto the connector with the plug-in attachment; and
removing the plug-in attachment.

13. The method as claimed in claim 12, further comprising adapting a length of the shrinkdown tubing overhang in front of the mating face of the connector in a mating direction to a place of deployment of the connector to form an apron.

14. The method as claimed in claim 13, wherein the shrinkdown tubing is made of a material that can be compressed at least in an area of the apron in the mating direction.

15. The method as claimed in claim 12, wherein the electrical connector comprises an at least partially metalized housing.
